(19) United States
(12) Patent Application Publication
(10) Pub. No.: US 2006/0155753 A1
(43) Pub. Date: Jul. 13, 2006

(54) Global asynchronous serialized transaction identifier

(76) Inventors: Marc Asher, Highland Park, IL (US); James Kargman, Chicago, IL (US)

Correspondence Address: LEVENFELD PEARLSTEIN;Intellectual Property Department, 2 North LaSalle, Suite 1300, CHICAGO, IL, 60602, US

(21) Appl. No.: 11/273,317

(22) Filed: Nov. 14, 2005

Related U.S. Application Data
(60) Provisional application No. 60/627,083, filed on Nov. 11, 2004.

(51) Int. Cl. G06F 7/00

(52) U.S. Cl. 707/102

(57) ABSTRACT

A system for storing and indexing unique computer transactions taken asynchronously across one or more systems such that a complete database of all transactions taken by all member systems can be recreated in a coherent time sequence in each member system.

### FIELD OF THE INVENTION

This application claims the benefit for priority purposes of US. Provisional Application, Application Ser. No. 60/627,083 filed Nov. 11, 2004 and entitled Global Asynchronous Serialized Transaction Identifier, which is incorporated by reference herein.

A system and a method for storing and indexing unique computer transactions taken asynchronously across one or more systems so that a complete database of all transactions taken by all member systems can be recreated in a coherent time sequence on each member system.

This type of system is useful when home delivery of pizzas or other restaurant meals is offered. Under this system the orders can be kept straight in the sequence they were placed.

The system and method of this invention provides data structuring, storage methods, and computer processes for accepting transactions across multiple separate database systems with each system containing a complete record of transactions taken across all systems stored in chronological order.

It is an object of this invention to provide a global asynchronous serialized transaction identifier processing system for storing and indexing unique computer transactions taken asynchronously across one or more systems, which comprises means for recreating a complete database of all transactions taken, by all member systems in a coherent time sequence on each member system.

Another object is to provide a global asynchronous serialized transaction identifier processing system comprising at least three components:

(a) a serialized transaction identifier (STI) generation component,

(b) a cross validation component,

(c) asynchronous cross-system journaling components.

In the aforedescribed processing system, the three components cooperate as follows:
(a) The STI generates an identifier value for transactions that is independently generated to be unique and the transaction identifier is generated to provide for transactions sequenced by this identifier to be coalesced at any time on other member systems in a consistent chronological sequence; and
(b) the cross index validation component creates multiple cross index entries based upon STI to enable internal consistency checks to be conducted to verify sequential integrity of transactions generated on local systems as well as to validate the uniqueness of STI components generated across multiple systems; and
(c) asynchronous cross system journaling components are used to establish procedures for exchanging data records between multiple systems in a local area network (LAN) and wider area network (WAN) configuration; and
(d) wherein raw data records indexed by the STI component are exported from each system generating source transaction and are imported asynchronously to one or more member systems, insuring through the use of the STI component that data elements are not overwritten.

Another object of this invention is to provide a method for storing and indexing computer transactions asynchronously across one or more systems so that a complete database of all transactions taken by all member systems can be recreated in a coherent time sequence on each member system, said method comprising:
(a) utilizing a serialized transaction identifier (STI) to generate an identifier value for transaction that is independently generated to be unique, utilizing the transaction identifier to provide for transactions sequenced by this identifier to be coalesced at any time on other member systems in a consistent chronological sequence; and
(b) utilizing a cross-index validation component to create multiple cross index entries utilizing STI to conduct internal consistency checks to verify sequential integrity of transactions generated on local systems and to validate the uniqueness of components generated by STI across multiple systems; and
(c) establishing procedures for exchanging data records between multiple systems in a local area network (LAN) and a wider area network (WAN) utilizing asynchronous cross system journaling components; and
(d) exporting raw data records from each system generating source transactions said data indexed utilizing STI and importing asynchronously to one or more member systems insuring through the use of STI component that data elements are not overwritten.

### BACKGROUND OF THE INVENTION

A prior art technique was to uniquely chronologically sequentially index data utilizing a clustered database approach whereby one or more systems all share a common database and use a common incremental counter for transaction indexing. This method ensures that as each member system requests the next transaction identifier it will be placed numerically sequential to a prior value requested by a different member systems. The prior art method requires a centralized database management process that queues and locks database requests of a transaction identifier from a system until a request for a separate system has been completed. A primary disadvantage of the prior art method is that it requires central arbitration and generation of transactional identifiers. Thus, the central process generating the transaction identifiers becomes a bottleneck and all systems are dependent upon the availability and reliability of that process.

It is clear that the aforecited prior art does not suggest or disclose the system and method claimed herein which provides a system and method for storing and indexing unique computer transactions taken asynchronously across one or more systems such that a complete database of all transactions taken by all member systems can be recreated in a coherent time sequence on each member system.

### SUMMARY OF THE INVENTION

This invention provides a global asynchronous serialized transaction identifier processing system comprising:

(a) a serialized transaction identifier (STI) generation component; and

(b) a cross index validation component; and

(c) asynchronous cross-system journaling components.

The advantage of the invention is that it allows multiple systems to operate independently for short or long durations but then have data taken by all member systems to be subsequently coalesced into a consistent set of data records that reflect transactions taken from across all systems. Each member system is independent of waiting for another member system to have a transaction identifier generated before proceeding with its own set of transactions.

This invention is useful in any environment where multiple database servers are desirable for transactional processing. The value in multiple discrete database servers is in both performance and reliability. This invention will be particularly useful in environments where multiple database servers are physically separated and the expense of maintaining high-speed data connections between each database server to maintain database consistency is not justified.

The invention comprises a serialized transaction identifier (STI) generation component, which generates an identifier value for the transaction that can be independently generated to be unique across all systems. The transaction identifier is generated in such a manner as to allow for transactions sequenced by this identifier to be coalesced at a later time on other member systems in a consistent chronological sequence. Generation of the identifier is done so as to be uniquely generated on a single system which may have multiple simultaneous processes creating transactions as well as unique across multiple systems which may not be in real time communication with the source system. The STI component provides that no two transactions could have the same order number.

Another component of the invention is cross-index validation. This component creates multiple cross-index entries based upon the serialized transaction identifier (STI) so that internal consistency checks can be run to verify sequential integrity of transactions generated on the local system as well as validate the uniqueness of transaction identifiers generated across multiple systems.

The third component, asynchronous cross-system journaling, involves established procedures for exchanging data records between multiple systems in a local area network (LAN) and/or wide area network (WAN) configuration. Raw data records indexed by STI are exported from each system generated by the source transaction and imported asynchronously to one or more member systems. The uniqueness of the STI ensures data elements are not overwritten.

The invention is made creating appropriate software code to generate the serialized transaction identifier (STI), create the cross-index validation component and setting up the cross-system journaling between one or more member systems.

### BRIEF DESCRIPTION OF THE DRAWINGS

FIG. 1 illustrates the serialized transaction identifier (STI) component.

FIG. 2 illustrates the cross-index valuation component.

FIG. 3 illustrates the asynchronous cross-system journaling component.

### DETAILED DESCRIPTION OF THE EMODIMENT

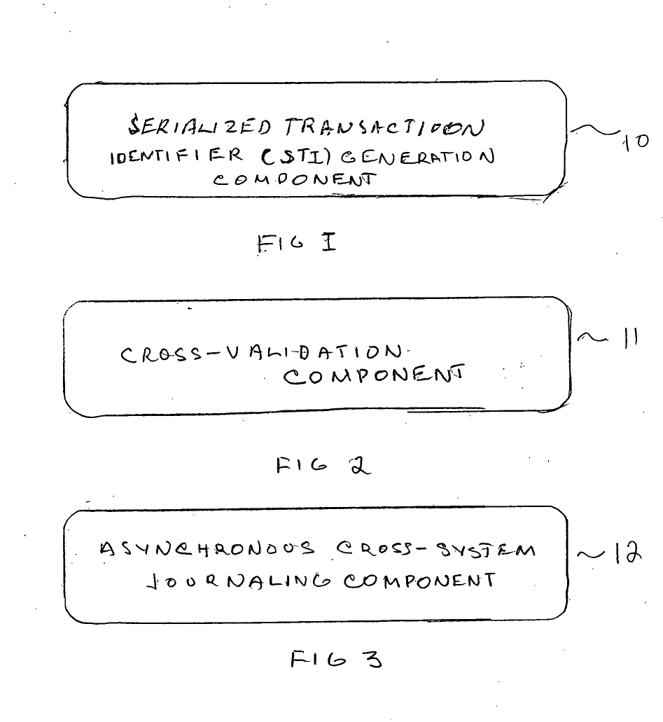

FIG. 1 illustrates the serialized transaction identifier (STI) component 10. The STI is a single integer value derived from the following:
(a) The date and time the STI was generated;
(b) A unique system ID on which the STI was generated; and
(c) A sequential identifier for multiple transactions generated at the identical date and time on the same system. The key element on the STI is the method in which these elements are assembled to generate a value that will have a chronological sort sequence across multiple systems.

The format of the STI is as follows:

<Century Digit><Year Digit 1><Year Digit 2>

<Month Digit 1><Month Digit 2><Day Digit 1>

<Day Digit 2><Time Digits><Sequence Digits><System ID Digits>

The Century Digit is defined as the number of centuries since 1700. Year Digit 1 and Year Digit 2 represent the year of the transaction in 2-digit format. For example, the year 2003 would have a century Digit of 3, Year Digit 1 of 0 and Year Digit 2 of 3. The Month Digit 1 and Month Digit 2 combine to form a 2 digit representation of the month of the transaction with “01” representing January and 12 representing December. The Day Digit 1 and Day Digit 2 combine to form a 2-digit representation of the day in the month of the transaction. The Time Digits represent the time of the transaction in 24 hour HHMMSS format (hours-minutes-seconds with ‘0’ padding). The Sequence Digit is an incremental value starting arbitrarily at “1” and incremented makes multiple transactions that are taken at the identical time on the same system. The system ID Digits are a unique system identifier set for each member system. By using the date and then time as the “high order” values in the generated STI, any transactions using the identifier will be automatically sorted in a chronological manner regardless of the particular System ID Digits.

FIG. 2 illustrates the cross-index validation component 11. This component creates multiple cross-index entries based upon STI so that internal consistency checks can be run to verify sequential integrity of transactions generated on the local system as well as validate the uniqueness of the transaction identifiers generated across multiple systems.

FIG. 3 illustrates the asynchronous cross-system journaling component 12. This component involves established procedures for exchanging data records between multiple systems in a local area network (LAN) and/or wide area network (WAN) configuration. Raw data records indexed by STI are exported from each system generating the source transaction and imported synchronously to one or more member systems. The uniqueness of the STI ensures that data elements are not overwritten.

In order to utilize 32 bit processors, the global asynchronous serialized transaction identifier processing systems utilizes 19 or less digits.

In the cross validation component there is generated an audit function, which is an integral part of the process that validates and assesses that transactions are all both generated as well as logged property.

In the asynchronous cross system journaling component there is provided a journal filter process that assures that transactions originating in one system are not applied twice to the same system.

In the STI component there is provided a method of distributed database activities establishing duplicate database to generate transactions that can later be coalesced into a consistent transaction image consistent with real time business transactions.

In one process, as many as the following number of transactions per second can be executed on the following number of systems:

| Systems Number | Transactions per Second |
|---|---|
| 999 | 999 |
| 99 | 9,999 |
| 9 | 99,999 |

It is known in the art to use transaction journaling—both before image journaling (an image of each block is taken before something is changed so that it can be replaced if the completion flag is not set). After image journaling (each transaction also writes out a logical image of itself which can then be applied to another database reflect the same transaction). After image journaling is part of the specifications for the NSI standard (and Federal Information Processing Standard) MUMPS (Massachusetts Utility Multi-Programming System) language (used in the Veteran's Administration, U.S. Air Forces and most of the hospitals in the U.S.), which is the foundation of the technology used today. This novel system is able to scale an application asynchronously. This invention allows the user to move machines into and out of production without regarding to the transactions because time sequence inherent in the key structure allows the user to reconcile the transactions in real time sequence across databases whether running at the same time or at different times.

The processing system of this invention utilizes 19 or less digits to enable the system to operate on computers having 32 bits. Examples of these are Intel Pentium, and AMD running under Microsoft Windows and/or Unix, Linux.

The 32-bit processors are a broad category of environments in which integer precision is particularly adapted. The STI is a pure integer value. The use of a long integer value as opposed to a string value (containing alphanumerics) or a decimal value is advantageous in that it requires far less storage space on a system. The specific limitation of 19 digits is set because it is the level of integer precision available for a long (4-byte) integer value. Any longer value used for calculations or storage become truncated and would result in loss of data embedded within the formulation of the STI (i.e. the date/time/sequence/system identification). On systems where the use of long multi-work integer values presents a problem, the use of alphameric values can be substituted to a maximum string length of from 20 to 255 bytes per key depending on the implementation, making possible a number of enhancements to the level of detail to which the keys can compartmentalize the data.

The audit function is the 2nd component listed as the “Cross-Index Validation”. The aspect of the cross-system journaling that prevents when a transaction is taken on system A, journaled and imported on system B, but then not subsequently journaled from system B to be loaded on system A (in effect creating an infinite loop), is an included set of functionality within the database environment. The presence of this functionality is essential to distribute the transactional processing across multiple systems.

The limitation of 999 transactions per second on a single system is not easily overcome while maintaining the STI as a 19-digit integer value owing to the fact that additional digits cannot be allocated for this single system serialization component or otherwise data loss will occur as the long integer digit precision will be overrun. Similarly, 19-digit formulation of the STI is also only suitable for up to 999 member servers, as only 3 digits are allocated for the server identification. However, all these limitations are overcome by transitioning from a pure integer index value to an alphanumeric value of arbitrary length. The alphanumeric value allows for additional digit positions for the single system serialized index component as well as for the system identification. The primary downside of shifting to a non-integer index value from a conceptual standpoint is the increase in storage required for the values. From an implementation-specific standpoint, the system, which has implemented this indexing scheme, would require several components that are presuming an integer transaction number to be rewritten. In any event, if an alphanumeric indexing scheme is adopted, the one critical element is that all member systems must use the same length generated STI to ensure consistent collating of the index values so as to preserve the chronological sequencing of the data.

Various modifications to the invention are contemplated. It is understood, therefore, that within the scope of the appended claims, the invention may be practiced otherwise than specifically described.

What is claimed is:

1. A global asynchronous serialized transaction identifier processing system comprising at least three components:
(a) A serialized transaction identifier (STI) generating component;
(b) A cross index validation component;
(c) An asynchronous cross-system journaling component.

2. The processing system of claim 1 wherein:
(a) The STI generates an identifier value for transactions that is independently generated, to be unique and the transaction identifier is generated to provide for transactions sequenced by this identifier to be coalesced at any time on other member systems in a consistent chronological sequence; and
(b) the cross index validation component creates multiple cross-index entries based upon the STI to enable internal consistency checks to be conducted to verify sequential integrity of transactions generated on local systems as well as to validate the uniqueness of STI components generated across multiple systems, and
(c) the asynchronous cross system journaling components used to establish procedures for exchanging data records between multiple systems in a local area network (LAN) and wide area network (WAN) configuration wherein raw data records included by STI component are exported from each system generating source transaction and imported asynchronogically to one or more member systems insuring through the use of the STI component that data elements are not overwritten.

3. A method for storing and indexing computer transactions asynchronologically across one or more systems so that a complete database of all transactions taken by all member systems can be recreated in a coherent time sequence on each member system by said method comprising:
(a) utilizing a serialized transaction identifier (STI) to generate an identifier value for transaction that is independently generated to be unique, utilizing the transaction identifier to provide for transactions sequenced by this identifier to be coalesced at any time on the member systems in a consistent chronological sequence; and
(b) utilizing a cross-index validation component to create multiple cross index entries utilizing STI to conduct internal consistency check to verify sequential integrity of transactions generated in local systems and to validate the uniqueness of components generated by STI across multiple systems; and
(c) establishing procedures for exchanging data records between multiple systems in a local area network (LAN) and a wide area network (WAN) utilizing asynchronous cross system journaling component; and
(d) exporting raw data records from each system generating source transactions, said data index utilizing STI and importing asynchronously to one or more member systems insuring through the use of STI component that data elements are not overwritten.

4. The processing system of claim 2 whereas in the cross index validation component there is a generated an audit function which is an integral part of the process that validates and assures that transactions are all both generated as well as logged properly.

5. The processing system of claim 2 wherein in the asynchronous cross system journaling component therein provides a journal filter process that assures that transactions originating in one system are not applied twice to the same system.

6. The processing system of claim 2 wherein said STI component is provided a method for distributed database activities enabling duplicate databases to generate transactions, that can later be coalesced into a consistent transaction image consistent with real time business transactions.

7. The processing system of claim 2 wherein as many as 999 transactions per second for each system for as many as 999 systems can be carried out.

8. The processing system of claim 2 wherein as many as 9,999 transactions per second for each system for as many as 99 systems can be carried out.

9. The processing system of claim 2 wherein as many as 99,999 transactions per second for each system for as many as 9 systems can be carried out.

10. The processing system of claim 2 wherein the system utilizes 19 or less digits to enable the system to operate on computers having 32 bits.

11. A global asynchronous serialized transaction identifier processing system for storing and indexing unique computer transactions taken asynchronously across one or more systems which comprises means for recreating a complete data base of all transactions taken by all member systems in a coherent time sequence on each member system.

12. The processing system of claim 2 wherein no two transactions can have the same order number.
